(19) United States
(12) Patent Application Publication
(10) Pub. No.: US 2013/0288780 A1
(43) Pub. Date: Oct. 31, 2013

(54) MODIFIED WAGERING GAME SYSTEMS AND METHODS

(71) Applicant: Inthavong Nanthavongdouangsy, Banning, CA (US)

(72) Inventor: Inthavong Nanthavongdouangsy, Banning, CA (US)

(21) Appl. No.: 13/725,532

(22) Filed: Dec. 21, 2012

Related U.S. Application Data
(60) Provisional application No. 61/639,884, filed on Apr. 28, 2012.

(51) Int. Cl. G07F 17/32; A63F 1/00

(52) U.S. Cl. CPC G07F 17/3244; A63F 1/00
USPC 463/25; 273/292

(57) ABSTRACT

Systems and methods for providing, conducting and hosting wagering games in which players may place wagers and receive player hands including one or more randomly generated playing cards that are compared with the rank and suit of a single playing card in the dealer hand, wherein any wagers received are settled by awarding a payout amount to the players having a player hand in which at least one card thereof has the characteristics of being a higher rank and the same suit as the single playing card in the dealer hand.

### CROSS-REFERENCE TO RELATED APPLICATIONS FROM WHICH PRIORITY IS CLAIMED

This application claims the benefit of U.S. Provisional Patent Application No. 61/639,884 which was filed Apr. 28, 2012, the disclosure of which is incorporated herein by reference.

### BACKGROUND

1. Field of the Invention

The present invention relates to systems and methods of providing, conducting and modifying wagering games. In particular, the invention relates to a system and method for providing and conducting a modified card game.

2. Description of the Related Art

Many card games have been developed over the years and some are particularly adapted for gambling. Typically, such games include a dealer who deals cards and one or more players who place wagers on whether an outcome will be achieved based on the cards that the dealer deals.

While many games currently exist, additional games and variations of existing wagering games are always of interest to players and gaming operators to maintain player interest, among other things, and may be provided in a variety of formats, including as a table game, electronic platform, or a combination thereof, or through a networked system. Thus, there continues to be a need for new games to compete with or replace the most popular games being played today.

### SUMMARY OF THE INVENTION

The invention relates generally to systems and methods of modifying, providing and conducting wagering games, and more particularly, multilayered wagering games.

Some embodiments of the invention are directed to a method of providing a wagering game at a gaming table comprising the steps of: displaying one or more wagering areas and indicia relating to associated wagering opportunities; providing one or more decks of randomly-ordered physical playing cards; receiving an ante wager from one or more participating players; distributing a player hand at the gaming table consisting of one or more playing cards to each of the one or more participating players from the one or more decks of physical playing cards; distributing a dealer hand at the gaming table including a single playing card from the one or more decks of physical playing cards; receiving a play wager from the participating player; revealing the rank and suit of the single playing card in the dealer hand at the gaming table; comparing the rank and suit of the single playing card in the dealer hand with the ranks and suits of each card of the one or more playing cards in the player hand of each of the one or more participating players; and settling the ante and play wagers received from the participating player by either awarding a payout amount to each of the one or more participating players having a player hand in which at least one card of the one or more playing cards has the characteristics of being a higher rank and the same suit as the single playing card in the dealer hand or collecting the ante and play wagers.

In some embodiments of the aforementioned method, the player hand consists of four cards. In some embodiments of the aforementioned method, the play wager is mandatory to avoid forfeiting the game resulting in the collection of the ante wager. In some embodiments, the play wager must be an amount equal to but no greater than three times ante wager.

In some embodiments, the aforementioned method further includes the steps of: receiving a bonus game wager from one or more players prior to distributing the player hands at the gaming table; determining a poker hand rank for each player hand at the gaming table from which a bonus game wager is received; comparing the poker hand rank determined for each player hand with a bonus game preset criteria, wherein the bonus game preset criteria sets forth payout amounts based on poker hand rank; and settling the bonus game wager received from the participating player by either awarding the payout amount set forth by the preset criteria satisfied or collecting the bonus game wager.

In some embodiments, the aforementioned method further includes the steps of: receiving a bonus game wager from one or more players prior to revealing the rank and suit of the single playing card in the dealer hand at the gaming table; determining a poker hand rank for a bonus game wager hand, wherein the bonus game wager hand includes the cards of each player hand at the gaming table from which a bonus game wager is received and the single playing card in the dealer hand; comparing the poker hand rank determined for each bonus game wager hand with a bonus game preset criteria, wherein the bonus game preset criteria sets forth payout amounts based on poker hand rank; and settling the bonus game wager received from the participating player by either awarding the payout amount set forth by the preset criteria satisfied or collecting the bonus game wager.

Some embodiments of the invention are directed to a system for providing a wagering game comprising: a communication device configured for receiving wagers from a participating player, wherein the wagers include an ante wager and play wager, and awarding payout amounts; and one or more processors configured for: facilitating the provision of data relating to a player hand responsive to the communication device receiving the ante wager, wherein the player hand consists of one or more randomly generated playing cards; facilitating the provision of data relating to a dealer hand, wherein the dealer hand includes a randomly generated single playing card; comparing the rank and suit of the single playing card in the dealer hand with the ranks and suits of each card of the one or more playing cards in the player hand responsive to the communication device receiving the play wager; and determining a payout amount based on the comparison, wherein a payout amount is awarded through the communication device if at least one card of the one or more playing cards has the characteristics of being a higher rank and the same suit as the single playing card in the dealer hand.

The system may further include a display device in communication with the one or more processors and communication device for displaying the randomly generated playing cards involved in the game. The one or more processors, display device and communication device may be mounted in a single electronic gaming platform or mounted independently from each other in remote locations.

The system, including the one or more processors, may be further configured to: determine a poker hand rank for the player hand responsive to the communication device receiving a bonus game wager; compare the poker hand rank determined for the player hand with a bonus game preset criteria, wherein the bonus game preset criteria sets forth payout amounts based on poker hand rank; and determine a payout amount to be awarded through the communication device if any of the preset criteria are satisfied.

Some embodiments of the invention are directed to a computer-implemented method of providing a wagering game, comprising one or more processors, communication devices and data storage devices, all for facilitating the steps of: receiving information relating to an ante wager placed by a participating player; transmitting information to the participating player relating to a player hand consisting of one or more randomly generated playing cards; transmitting information to the participating player relating to a dealer hand including a single randomly generated playing card; receiving information relating to a play wager placed by the participating player; transmitting information to the participating player relating to the rank and suit of the single randomly generated playing card in the dealer hand; and transmitting information to the participating player relating to the outcome of the ante and play wagers placed, wherein the information transmitted either includes a notification of the awarding of a payout amount if at least one card of the one or more randomly generated playing cards in the player hand has the characteristics of being a higher rank and the same suit as the single randomly generated playing card in the dealer hand or a notification that the ante and play wagers have been lost.

In some embodiments, the communication devices transmit information via a global telecommunication and/or computing network. The one or more processors, communication devices and data storage devices may be mounted in a unitary housing or remotely from one another.

The one or more processors, communication devices and data storage devices may be further configured for: receiving information relating to a bonus game wager placed by the participating player; transmitting information to the participating player relating to the outcome of the bonus game wager placed, wherein the information transmitted either includes a notification of the awarding of a payout amount if the one or more randomly generated playing cards in the player hand achieve at least a preset poker rank or a notification that the bonus game wager has been lost.

The one or more processors, communication devices and data storage devices may also be further configured for: receiving information relating to a bonus game wager placed by the participating player; transmitting information to the participating player relating to the outcome of the bonus game wager placed, wherein the information transmitted either includes a notification of the awarding of a payout amount if the one or more randomly generated playing cards in the player hand and the dealer hand achieve at least a preset poker rank or a notification that the bonus game wager has been lost.

Some embodiments of the invention are also directed to a non-transitory machine readable media for providing a wagering game associated with an underlying game including one or more software programs, code and/or data segments as necessary to provide any of the methods described herein on one or more machines or to facilitate the installation and operation of such methods in systems described herein.

### BRIEF DESCRIPTION OF THE DRAWINGS

FIG. 1 is a process flow chart depicting an exemplary embodiment of the invention.

FIG. 2 is process flow chart depicting another exemplary embodiment of the invention.

FIG. 3 is a schematic diagram of an exemplary table layout configured for use with methods according to some embodiments of the invention, including physical or live table systems and virtual or partially virtual electronic platforms.

FIG. 4 is a schematic diagram of exemplary system components configured for use with methods according to some embodiments of the invention.

### DETAILED DESCRIPTION OF THE INVENTION

The exemplary embodiments herein relate to wagering games. It should be understood that each of the methods and individual steps recited herein may be partially or wholly carried out in a variety of ways and/or systems, which may include, but are not limited to, a live dealer physically dealing playing cards in a casino, an electronic gaming machine (EGM) for use by one or more players, a multiplayer platform which may include a player interface such as a touchscreen display and involve physical or virtual playing cards, dealer and wagering chips, a home computer or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve wagering, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game.

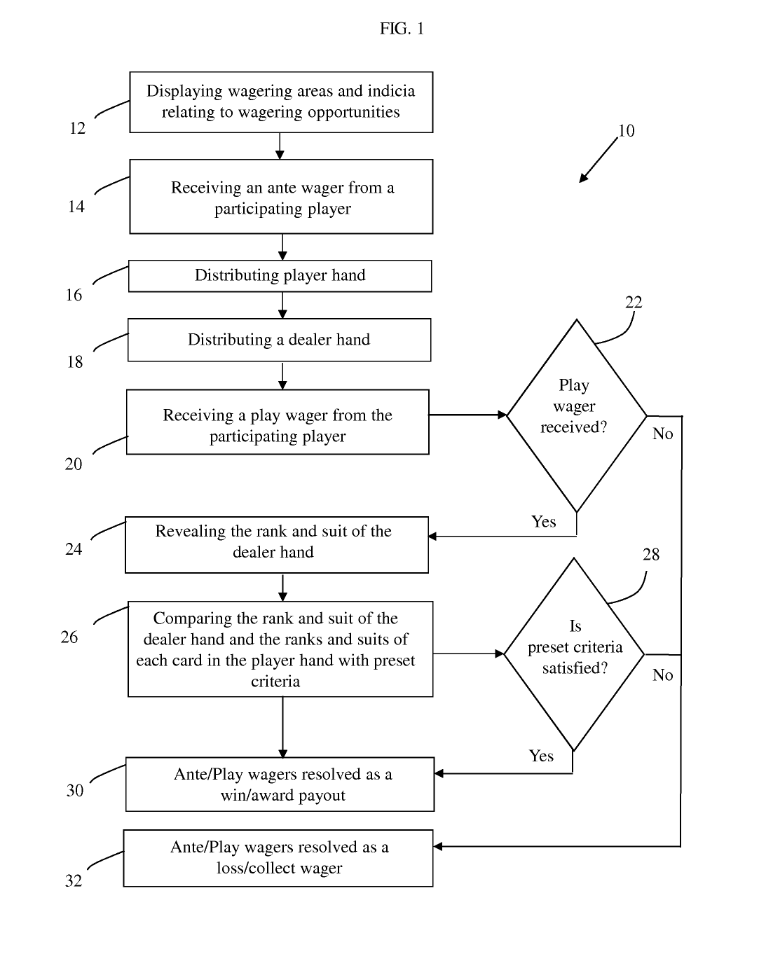

A method of conducting a wagering game according to some embodiments of the invention is generally referred to by the reference numeral 10 in FIG. 1.

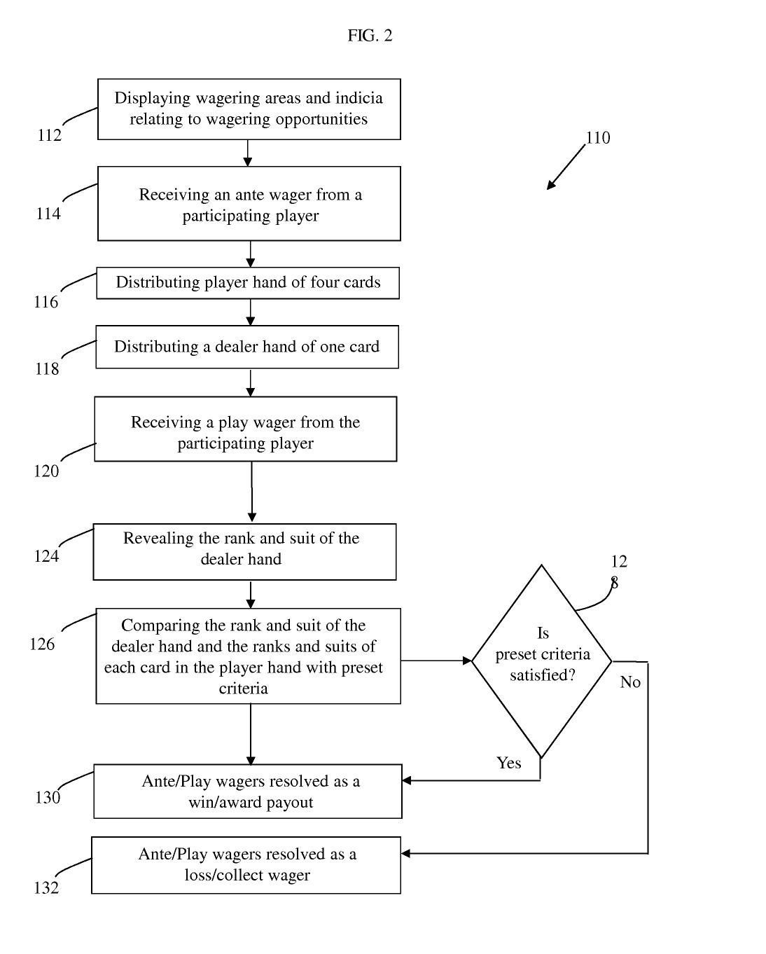

As shown by step 12, method 10 may be facilitated by providing a table layout such as layout 50 shown in FIG. 2 so that wagering areas and indicia relating to wagering opportunities may be displayed to potential players and used for the placement of wagers thereon.

In step 14, an ante wager is placed and received by the gaming operator or house. As indicated by step 16, a player hand is distributed. This may involve dealing cards one by one or by providing a hand of cards, however, players may view the identity of the cards in the player hand. In an exemplary embodiment discussed herein the player hand includes four cards, but more or less cards may be used in the player hand. For example, the player hand may include three or five cards instead of four.

As shown by step 18, a dealer hand is distributed. It should be understood that the terminology “dealer hand” is simply used for convenience sake, and it may be referred to by another name, such as the “house hand.” The dealer hand is dealt in a manner which does not reveal its identity, such as by being dealt face down on a gaming table. In the exemplary embodiment discussed herein the dealer hand includes a single card but it should be understood that the dealer hand may include more cards in other embodiments.

As shown by step 20, an additional wager, referred to hereinafter as a “play” wager is received from the players. The play wager may be any amount, but in some embodiments the play wager is limited to being a multiple of the ante wager, such as 1, 2 or 3 times the ante wager. As shown by steps 22 and 24, if the play wager is received, then the rank and suit of the dealer hand is revealed. However, if the player wager is not received, then as shown by steps 22 and 32, the game is forfeited, and the ante wager is resolved as lost and subsequently collected. In other embodiments, such as the one disclosed in FIG. 2, a play wager may not be received in that the player may choose to stand on the ante wager and continue to play without forfeiting the game.

Assuming the play wager is received in step 20 and the dealer hand is revealed in step 24, the rank and suit of the cards in the dealer hand and the player hand will be compared with preset criteria. The preset criteria of the exemplary embodiment described herein is satisfied if the player hand includes at least one card which is the same suit (i.e., “suited”) and of a higher rank than (i.e., “outranks”) any cards or card in the dealer hand. For purposes of the exemplary embodiment, the ranking system has a hierarchy similar to poker, that is, with Aces being the highest ranked, then Kings, Queens, Jacks, and numerically thereafter decreasing from Tens to Deuces, wherein Deuces are the lowest ranked cards.

In the embodiment described herein below, where the dealer hand includes a single card and the player hand includes four cards, the rank and suit of the single card and the respective rank and suit of each of the four cards will be compared with the preset criteria, wherein the preset criteria is satisfied upon the player hand including at least one card which is suited and outranks the single card in the dealer hand.

As shown by steps 28 and 30, if the preset criteria are satisfied then the ante and play wagers are resolved as a win and the player is awarded a payout amount. The payout amount may be based on the ante and play wagers, such as a payout of even money or 1 to 1 ratio.

As shown by steps 28 and 32, if the preset criteria are not satisfied then the ante and play wagers are both resolved as lost and subsequently collected.

Method 110 as shown in FIG. 2 illustrates another embodiment of the invention in which the player hand consists of four cards, the dealer hand consists of a single card and the play wager is not mandatory, but functions similar to a “raise” in poker. For example, a player receiving a player hand of four higher-ranking cards with each of a different suit may wish to raise by wagering more since they have higher odds of satisfying the preset criteria of outranking the dealer hand regardless of the suit. The remaining steps of method 110 are substantially the same as the steps of method 10.

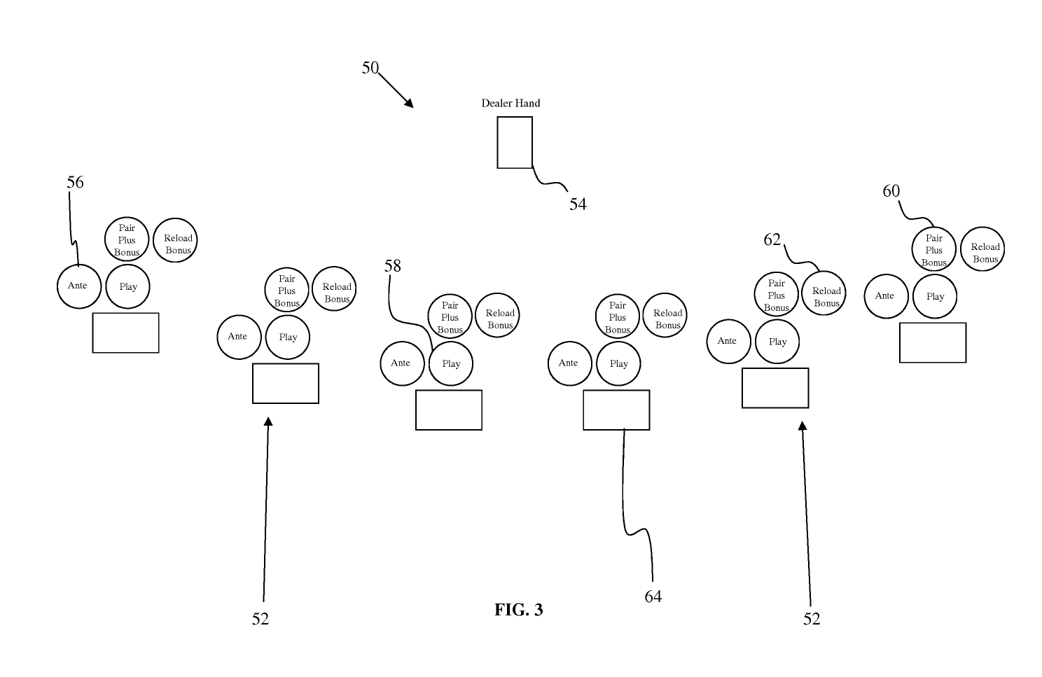

As mentioned above, layout 50 shown in FIG. 3 is intended to facilitate play of a method according to the invention, such as methods 10 and 110. Layout 50 includes multiple player positions 52 and a dealer hand position 54. Player positions include an ante wager area 56, a play wager area 58, an optional pair plus bonus wager area 60, and an optional reload bonus wager area 62, all on which wagers in the form of chips or tokens may be placed. A pair plus bonus may be won depending on certain poker related criteria being satisfied by the cards dealt to the player hand. The reload bonus wager may be won depending on certain poker related criteria being satisfied by a hand formed by a combination of the player hand and the dealer hand. The pair plus wager must be placed in area 60 prior to distributing the player hands, whereas the reload bonus wager may be placed in area 62 after the player hand has been distributed but before the dealer hand has been revealed. In some embodiments, the pair plus bonus and reload bonus are paid regardless of the ultimate outcome of the underlying game method described herein and as shown in FIGS. 1 and 2. Cards may be distributed or dealt to card area 64 in each player positions 52. In some embodiments, players must place an ante wager to be able to place a pairs plus wager and in some embodiments players must place an ante wager and pairs plus wager in order to place a reload bonus wager. In some embodiments, players may place a pair plus and/or reload wager without placing an ante wager and/or pair plus wager, respectively.

The following table provides exemplary payout awards expressed as multiples of the wager received in pair plus bonus wagering area 60.

| | Exemplary payout for |
|---|---|
| Pair Plus Bonus Game Preset Criteria | Pair Plus wager |
| 4 Aces | 100 to 1 |
| 4 cards Royal Flush | 70 to 1 |
| Four of a kind | 50 to 1 |
| Four cards Straight Flush | 30 to 1 |
| Three of a kind | 6 to 1 |
| 4 cards Straight | 5 to 1 |
| 4 Cards Flush | 4 to 1 |
| Two Pairs | 3 to 1 |
| Any Pair | 1 to 1 |

The following table provides exemplary payout awards expressed as multiples of the wager received in reload bonus wagering area 62.

| | Exemplary payout for |
|---|---|
| Reload Bonus Game Preset Criteria | Reload wager |
| 4 Aces | 60 to 1 |
| 4 cards Royal Flush | 45 to 1 |
| Four of a kind | 30 to 1 |
| Four cards Straight Flush | 20 to 1 |
| Full House | 9 to 1 |
| Three of a kind | 5 to 1 |
| 4 cards Straight | 4 to 1 |
| 4 Cards Flush | 3 to 1 |
| Two Pairs | 2 to 1 |
| Any Pair | 1 to 1 |

In some embodiments, a method of the invention, such as method 10, and layout 50 may further include additional wagering opportunities, such as for example, an opportunity to place a wager on a progressive jackpot. The progressive wager may be placed on a corresponding area on a layout of the invention such as layout 50. In some embodiments, players must place the ante wager to place a progressive wager. In some embodiments, the progressive wager may payout 100% for a five card Royal Flush hand formed of the player's hand of four cards and the dealer's card, 50% for a four card Royal Flush hand formed of the player's hand only, and 50% for a player's hand consisting of Four of a Kind. In other embodiments, other configurations of either the player's hand by itself or in combination with the dealer's hand may be used for determining payouts from the progressive jackpot.

In some embodiments, the table layout may be provided via a computer interface. Alternatively, the game methods according to the invention may be implemented and presented by means of computer program code which, by way of example, when executed by a processor, causes the display of the wagering options described herein and game layout.

Those skilled in the art will readily appreciate that the methods described herein may be incorporated in an electronic gaming system in accordance with the invention using virtual representations of table layouts such as layout 50. The system of the invention may include various computer and network related software and hardware, such as programs, operating systems, memory storage devices, data input/output devices, data processors, servers with links to data communication systems, wireless or otherwise, and data transceiving terminals. Those skilled in the art will further appreciate that the precise types of software and hardware used are not vital to the full implementation of the methods of the invention so long as players and operators thereof are provided with useful access thereto, either through a gaming platform, or a mobile device or other computing platform via a global telecommunication network.

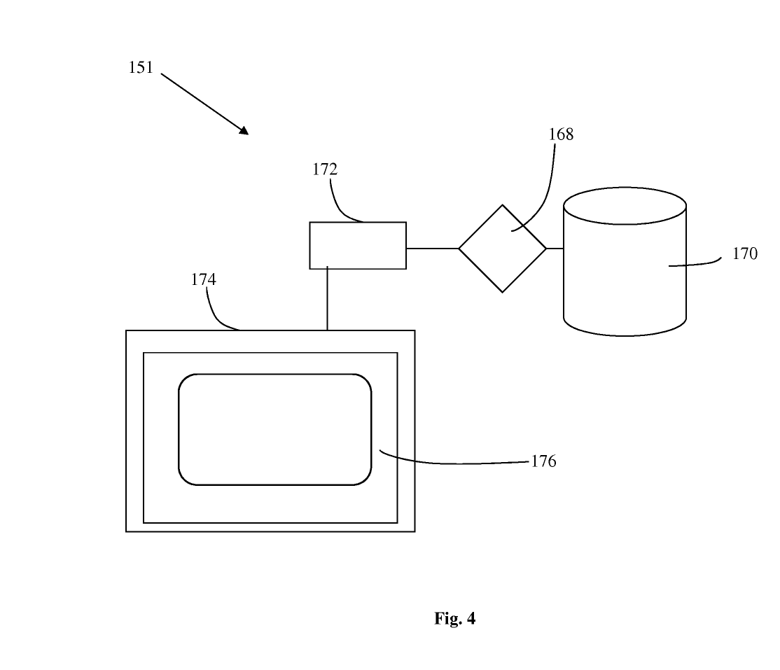

FIG. 4 illustrates an exemplary system 151 constructed in accordance with some embodiments of the invention. System 151 includes processing device 168 in communication with a database or memory device 170, communication or data input/output device 172 and a display device 174. In some embodiments, display device 174 is a touch-enabled device and includes a data input device component. Memory device 170 may include data relating to the underlying game and embodiments of the invention as described herein, such as the preset criteria. A virtual representation of a layout such as layout 50 and one or more player positions 176 may be displayed on display device 174 for facilitating the transmittal and receipt of wagers in accordance with any of the embodiments herein, such as methods 10 and 110. Game outcomes are displayed and wagers are tracked using display device 174 and processing device 168 compares the underlying game outcome with the preset criteria, storing information relating to the satisfaction of the preset criteria in memory 170. Processing device 168 compares the preset criteria with the underlying game outcome stored in memory 170. Should the preset criteria be satisfied, a payout will be determined by processing device 168 and indicated on display device 174. If the preset criteria are not satisfied, the same is indicated on display device 174.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A method of providing a wagering game at a gaming table comprising the steps of:
displaying one or more wagering areas and indicia relating to associated wagering opportunities;
providing one or more decks of randomly-ordered physical playing cards;
receiving an ante wager from one or more participating players;
distributing a player hand at the gaming table consisting of one or more playing cards to each of the one or more participating players from the one or more decks of physical playing cards;
distributing a dealer hand at the gaming table including a single playing card from the one or more decks of physical playing cards;
receiving a play wager from the participating player;
revealing the rank and suit of the single playing card in the dealer hand at the gaming table;
comparing the rank and suit of the single playing card in the dealer hand with the ranks and suits of each card of the one or more playing cards in the player hand of each of the one or more participating players; and
settling the ante and play wagers received from the participating player by either awarding a payout amount to each of the one or more participating players having a player hand in which at least one card of the one or more playing cards has the characteristics of being a higher rank and the same suit as the single playing card in the dealer hand or collecting the ante and play wagers.

2. The method according to claim 1, wherein the player hand consists of four cards.

3. The method according to claim 1, wherein the payout award is equal to the ante and play wagers.

4. The method according to claim 1, wherein the play wager must be an amount equal to but no greater than three times ante wager.

5. The method according to claim 1 further comprising the steps of:
receiving a bonus game wager from one or more players prior to distributing the player hands at the gaming table;
determining a poker hand rank for each player hand at the gaming table from which a bonus game wager is received;
comparing the poker hand rank determined for each player hand with a bonus game preset criteria, wherein the bonus game preset criteria sets forth payout amounts based on poker hand rank; and
settling the bonus game wager received from the participating player by either awarding the payout amount set forth by the preset criteria satisfied or collecting the bonus game wager.

6. The method according to claim 1 further comprising the steps of:
receiving a bonus game wager from one or more players prior to revealing the rank and suit of the single playing card in the dealer hand at the gaming table;
determining a poker hand rank for a bonus game wager hand, wherein the bonus game wager hand includes the cards of each player hand at the gaming table from which a bonus game wager is received and the single playing card in the dealer hand;
comparing the poker hand rank determined for each bonus game wager hand with a bonus game preset criteria, wherein the bonus game preset criteria sets forth payout amounts based on poker hand rank; and
settling the bonus game wager received from the participating player by either awarding the payout amount set forth by the preset criteria satisfied or collecting the bonus game wager.

7. A system for providing a wagering game comprising:
a) a communication device configured for receiving wagers from a participating player, wherein the wagers include an ante wager and play wager, and awarding payout amounts; and
b) one or more processors configured for:
i) facilitating the provision of data relating to a player hand responsive to the communication device receiving the ante wager, wherein the player hand consists of one or more randomly generated playing cards;
ii) facilitating the provision of data relating to a dealer hand, wherein the dealer hand includes a randomly generated single playing card;
iii) comparing the rank and suit of the single playing card in the dealer hand with the ranks and suits of each card of the one or more playing cards in the player hand responsive to the communication device receiving the play wager; and
iv) determining a payout amount based on the comparison, wherein a payout amount is awarded through the communication device if at least one card of the one or more playing cards has the characteristics of being a higher rank and the same suit as the single playing card in the dealer hand.

8. The system according to claim 7, further comprising a display device in communication with the one or more processors and communication device for displaying the randomly generated playing cards involved in the game.

9. The system according to claim 8, wherein the one or more processors, display device and communication device are mounted in a single electronic gaming platform.

10. The system according to claim 8, wherein the display device is in remote communication with the one or more processors.

11. The system according to claim 7, wherein the one or more processors and communication device are further configured to:
determine a poker hand rank for the player hand responsive to the communication device receiving a bonus game wager;
compare the poker hand rank determined for the player hand with a bonus game preset criteria, wherein the bonus game preset criteria sets forth payout amounts based on poker hand rank; and
determine a payout amount to be awarded through the communication device if any of the preset criteria are satisfied.

12. A computer-implemented method of providing a wagering game, comprising one or more processors, communication devices and data storage devices, all for facilitating the steps of:
receiving information relating to an ante wager placed by a participating player;
transmitting information to the participating player relating to a player hand consisting of one or more randomly generated playing cards;
transmitting information to the participating player relating to a dealer hand including a single randomly generated playing card;
receiving information relating to a play wager placed by the participating player;
transmitting information to the participating player relating to the rank and suit of the single randomly generated playing card in the dealer hand; and
transmitting information to the participating player relating to the outcome of the ante and play wagers placed, wherein the information transmitted either includes a notification of the awarding of a payout amount if at least one card of the one or more randomly generated playing cards in the player hand has the characteristics of being a higher rank and the same suit as the single randomly generated playing card in the dealer hand or a notification that the ante and play wagers have been lost.

13. The computer-implemented method according to claim 12, wherein the communication devices transmit information via a global computing network.

14. The computer-implemented method according to claim 12, wherein the communication devices transmit information via a satellite network.

15. The computer-implemented method according to claim 12, wherein the one or more processors, communication devices and data storage devices are mounted in a unitary housing.

16. The computer-implemented method according to claim 12, wherein the one or more processors, communication devices and data storage devices are further configured for:
receiving information relating to a bonus game wager placed by the participating player; and
transmitting information to the participating player relating to the outcome of the bonus game wager placed, wherein the information transmitted either includes a notification of the awarding of a payout amount if the one or more randomly generated playing cards in the player hand achieve at least a preset poker rank or a notification that the bonus game wager has been lost.

17. The computer-implemented method according to claim 12, wherein the one or more processors, communication devices and data storage devices are further configured for:
receiving information relating to a bonus game wager placed by the participating player; and
transmitting information to the participating player relating to the outcome of the bonus game wager placed, wherein the information transmitted either includes a notification of the awarding of a payout amount if the one or more randomly generated playing cards in the player hand and the dealer hand achieve at least a preset poker rank or a notification that the bonus game wager has been lost.
